(19) United States
(12) Patent Application Publication
(10) Pub. No.: US 2026/0017132 A1
(43) Pub. Date: Jan. 15, 2026

(54) SYSTEMS AND METHODS FOR CODING ROOT CAUSE SUBROUTINES

(71) Applicant: Capital One Services, LLC, McLean, VA (US)

(72) Inventor: Behrouz SAGHAFI, Frisco, TX (US)

(73) Assignee: Capital One Services, LLC, McLean, VA (US)

(21) Appl. No.: 18/771,890

(22) Filed: Jul. 12, 2024

(51) Int. Cl. G06F 11/07

(52) U.S. Cl. CPC G06F 11/079; G06F 11/0709

(57) ABSTRACT

Methods and systems are described herein for identifying one or more variables as key drivers of shift in a value of interest. In some aspects, a root cause analysis system may implement a subroutine to use feature contributions to identify the contributions of each variable in a baseline dataset and an updated dataset, where a value of interest has shifted between the baseline and updated datasets. By taking the difference in feature contributions between the datasets, the system may identify those variables with the largest shift in contribution as principal drivers of change for a value of interest. In some aspects, a root cause analysis system may implement a subroutine to generate partial dependence plots (PDPs) for each feature. By comparing different PDPs for each feature, the system may identify the features with significantly different feature-target relationships and find the key segments responsible for performance change.

### SUMMARY

Root cause analysis is a critical process that helps entities identify and address underlying causes of problems or incidents causing shifts. Root cause analysis is a systematic approach that often goes beyond treating the overt symptoms of a problem and instead focuses on identifying and rectifying the root causes. For example, in analogous medical applications, conducting a root cause analysis can enable medical professionals to find factors that lead to undesired clinical outcomes. By identifying the root causes of these events, organizations can develop strategies to reduce future errors and improve patient care and safety. Similarly, root cause analysis can be used in education, where techniques can be used to identify factors that can be used to address issues related to student performance, teacher effectiveness, and school management.

While root cause analysis techniques are powerful tools for mitigating issues and preventing future issues in various sectors, many such techniques do not adequately show the specific contributions of different variables, which can limit their ultimate effectiveness. This limitation can lead to an incomplete understanding of the problem and potentially yield ineffective solutions. For example, in healthcare, conventional techniques may identify a medication error as the cause of a patient's adverse reaction, but not adequately consider the contributing factors such as staff training, communication issues or system design flaws.

Accordingly, a mechanism is desired that would allow an operator to code a root cause subroutine to enable identification of one or more variables as principal drivers of change for a value of interest due to data drift, which, for example, enables users to see specific contributions of different variables that may be responsible for contributing to shifts in the value of interest. For example, using a first technique or subroutine, a system may use feature contributions (e.g., average feature contributions) to identify the contributions of each variable in a baseline dataset and an updated dataset, where a value of interest has shifted between the baseline and updated datasets. By taking the difference in feature contributions between the datasets, the system may identify specific contributions of each variable, and those with the largest shift in average contributions can be identified as key drivers of shift in the value of interest.

In the first subroutine, a system may receive, e.g., from a user, a request for identifying one or more variables (e.g., features) responsible for shift in the value of interest (e.g., target value) due to data drift, wherein the request comprises (1) a baseline dataset and (2) an updated dataset, wherein the updated dataset exhibits a change in the average value of interest as compared to the baseline dataset. The system may generate, using one or more machine learning models, a baseline model indicative of a relationship between the value of interest and each variable of the set of variables based on the baseline dataset. Using a model interpretability method, the system may process the baseline model using the baseline dataset and updated dataset with the model interpretability method to obtain a first and second matrix, wherein each matrix comprises quantitative measures of a contribution of each variable in the set of variables to the value of interest for each sample. Then the system may identify the principal drivers of change due to data drift by computing the difference between each of a plurality of column averages of the first matrix and a corresponding plurality of column averages of the second matrix and taking the highest absolute values.

In another example, e.g., a second subroutine, a system may generate partial dependence plots (PDPs) for each feature being analyzed as potentially contributing to the change in the target value. By comparing different PDPs for each feature, the system can find the features with significantly different feature-target relationships and find the key segments with concept drift. For example, the system may obtain a request for identifying one or more segments as principal drivers of change for a value of interest due to concept drift, wherein the request comprises (1) a baseline dataset and (2) an updated dataset, wherein the updated dataset exhibits a change in the average value of interest as compared to the baseline dataset.

The system may generate, using one or more machine learning models, a baseline model indicative of a relationship between the value of interest and each variable of the set of variables based on the baseline dataset and an updated model indicative of a relationship between the value of interest and each variable of the set of variables based on the updated dataset. The system may generate (1) a first plurality of plots, wherein each plot of the first plurality of plots illustrates the relationship between a variable of the set of variables and the value of interest in the baseline dataset, and (2) a second plurality of plots, wherein each plot of the second plurality of plots illustrates the relationship between the variable and the value of interest in the updated dataset. For each variable (e.g., feature), a differential value by comparing plots corresponding to a same variable of the set of variables from the first plurality of plots and second plurality of plots over the same segment may be determined. From the set of bins, the one or more bins having the most differential value may be identified as the bins with highest concept drift responsible for shift in the target value.

In particular, the first and second subroutines discussed herein provide many benefits over existing solutions for identifying key drivers of change. For example, the first subroutine is suitable for both linear and nonlinear data and does not require feature segmentation. As another example, the second subroutine fully eliminates the effect of other features when considering the effect of the feature being considered. In this way, the second subroutine enables users to see more clearly the actual relationship between each feature and the target value of interest without noise from other features not being considered. The second subroutine also does not require feature segmentation.

Various other aspects, features, and advantages of the systems and methods described herein will be apparent through the detailed description and the drawings attached hereto. It is also to be understood that both the foregoing general description and the following detailed description are examples and are not restrictive of the scope of the disclosure. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1A shows an illustrative environment for identifying one or more variables as principal drivers of change for a value of interest due to data drift, in accordance with one or more embodiments of this disclosure.

FIG. 1B shows an illustrative system for identifying one or more variables as principal drivers of change for a value of interest due to data drift using feature contributions, in accordance with one or more embodiments of this disclosure.

FIG. 1C shows an illustrative system for identifying one or more variables as principal drivers of change for a value of interest due to concept drift using partial dependence plots (PDPs), in accordance with one or more embodiments of this disclosure.

FIG. 2 illustrates an exemplary user interface at which a user can input a request for identifying one or more variables or segments as principal drivers of change for a value of interest, in accordance with one or more embodiments of this disclosure.

FIG. 3 illustrates an exemplary data structure of model interpretability values, e.g., a two-dimensional (2D) matrix of feature contributions, in accordance with one or more embodiments of this disclosure.

FIG. 4A illustrates an exemplary graph illustrating average feature contribution values for the set of features generated by aggregating model interpretability values obtained by processing the baseline model using the baseline dataset, in accordance with one or more embodiments of this disclosure.

FIG. 4B illustrates an exemplary graph illustrating average feature contribution values for the set of features generated by aggregating model interpretability values obtained by processing the baseline model using the updated dataset, in accordance with one or more embodiments of this disclosure.

FIG. 5 illustrates an exemplary population shift graph illustrating an absolute difference between the average feature contribution values from the exemplary graph of FIGS. 4A-4B, in accordance with one or more embodiments of this disclosure.

FIG. 6A illustrates an exemplary partial dependence plot (PDP) illustrating the relationship between a variable of the set of variables and the value of interest in the baseline dataset, in accordance with one or more embodiments of this disclosure.

FIG. 6B illustrates an exemplary partial dependence plot (PDP) illustrating the relationship between a variable of the set of variables and the value of interest in the updated dataset, in accordance with one or more embodiments of this disclosure.

FIG. 7 is an exemplary graphical interface identifying one or more variables as principal drivers of change for a value of interest, in accordance with one or more embodiments of this disclosure.

FIG. 8 illustrates a computing system, in accordance with one or more embodiments of this disclosure.

FIG. 9A is a flowchart of operations for identifying one or more variables as principal drivers of change for a value of interest using feature contributions, in accordance with one or more embodiments of this disclosure.

FIG. 9B is a flowchart of operations for identifying one or more variables as principal drivers of change for a value of interest using partial dependence plots (PDPs), in accordance with one or more embodiments of this disclosure.

FIG. 10 shows illustrative components for a system used to identify one or more variables as principal drivers of change for a value of interest, in accordance with one or more embodiments of this disclosure.

### DETAILED DESCRIPTION

In the following description, for the purposes of explanation, numerous specific details are set forth in order to provide a thorough understanding of the disclosed embodiments. It will be appreciated, however, by those having skill in the art, that the embodiments may be practiced without these specific details, or with an equivalent arrangement. In other cases, well-known models and devices are shown in block diagram form in order to avoid unnecessarily obscuring the disclosed embodiments. It should also be noted that the methods and systems disclosed herein are also suitable for applications unrelated to source code programming.

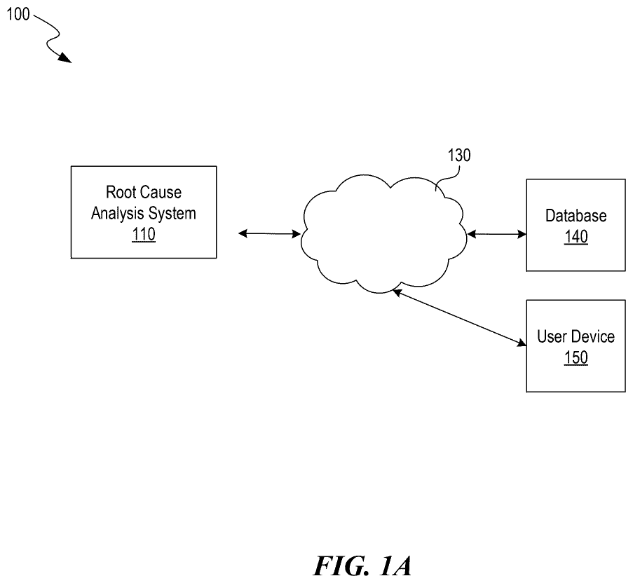

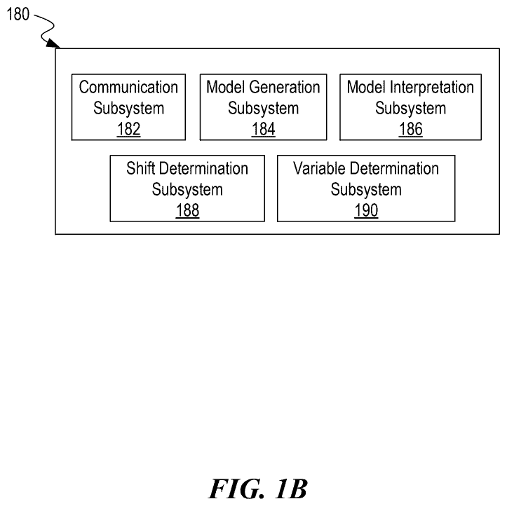

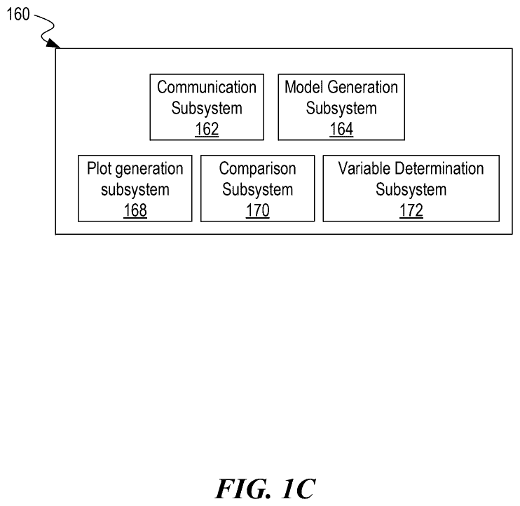

Environment 100 of FIG. 1A is an example environment that may be used for identifying one or more variables as principal drivers of change for a value of interest, e.g., from a set of variables. For example, such an environment may be used to identify a root cause in a sudden uptick in housing cost, e.g., among different variables such as house size, number of rooms, house age, etc. in order to mitigate current problems such as a housing affordability crisis and/or to predict and prevent similar issues in the future. Environment 100 includes root cause analysis system 110, database 140, and user device 150. Root cause analysis system 110 may be configured to identify one or more variables (e.g., house size) that are principal drivers of change for a value of interest due to data drift for a target value of interest (e.g., house cost) using one or more different techniques. For example, the root cause analysis system 110 may execute instructions to identify one or more variables, e.g., from a set of variables. In some examples, the root cause analysis system may be configured to identify causation, correlation, contributory effect or any key drivers of shift.

Root cause analysis system 110 may be configured to use one or more different techniques to identify such variables. For example, one such first technique may utilize feature contributions of different variables, e.g., where feature contributions include a measure of the extent to which each feature or variable in a dataset influences the predictions made by a model. Such a technique may include generating a model using datasets and calculating a feature contribution for each variable.

In another example, the root cause analysis system 110 may be configured to use a second technique that uses partial dependence plots to identify variables as principal drivers of change for a value of interest. For example, such PDPs may be used to show the marginal effects of features (e.g., variables) on the predicted outcomes of a model. By enabling visualization of partial dependence of features, the system may enable users to gain insights into complex relationships of variables that cause different model behavior. For example, root cause analysis can be applied in financial contexts, spanning from understanding the primary drivers behind delinquency changes in various quarters/years to identifying the key factors contributing to revenue changes in different states/geolocations.

Root cause analysis system 110 may include software, hardware, or a combination of the two that enables the system to perform one or more techniques described herein. For example, root cause analysis system 110 may be a physical server or a virtual server that is running on a physical computer system. In some embodiments, root cause analysis system 110 may be configured on a user device (e.g., a laptop computer, a smartphone, a desktop computer, an electronic tablet, or another suitable user device).

The root cause analysis system 110 may be communicatively coupled to the database 140 and/or user device 150 via network 130, where network 130 may include a local area network, a wide area network (e.g., the Internet), or a combination of the two. The root cause analysis system 110 may perform techniques to identify variables based on receiving requests to do so, e.g., from a remote user. For example, the root cause analysis system may receive requests for identifying variables from a set of variables as principal drivers of change for a target value of interest via network 130, such as from the user device 150. The request may include one or more datasets or may include identifiers that identify datasets stored at database 140 that exhibit changes in the value of interest. A user, such as an individual or an entity, can generate and transmit a request for identifying principal drivers of change for a value of interest via the user device 150, e.g., through a user interface at the user device 150 (e.g., mobile phone, computer, smart device, etc.). The user may use input methods such as keyboard input, mouse clicks, touch input, gesture recognition, and/or voice command to generate a request. In some embodiments, the request may include (1) the set of variables, (2) a baseline dataset, and (3) an updated dataset, where the updated dataset exhibits a change in the value of interest as compared to the baseline dataset.

For example, where the target value of interest is housing cost, the baseline dataset may include samples where the target value of interest is of a first value, and the updated dataset may include samples that exhibit a significant divergence from the first value (e.g., significantly higher). Alternatively, or additionally, rather than identifying the baseline and updated datasets separately, the request may include data comprising a plurality of samples. The root cause analysis system may be enabled to extract the baseline and updated dataset from the data, e.g., by partitioning the samples based on a threshold value of interest, such that the updated dataset exhibits a change in the value of interest as compared to the baseline dataset. For example, if the house cost is much higher for a select subset of samples in the data, the system may partition those samples in a separate dataset and use this dataset as the updated dataset. In some examples, rather than the request including the data or datasets directly, the request may include identifiers that identify the location of filenames associated with the baseline and updated datasets in memory (e.g., the database 140). For example, the request may include identifiers to data structures in memory, and root cause analysis system 110 may be configured to obtain the datasets based on the identifiers from the request.

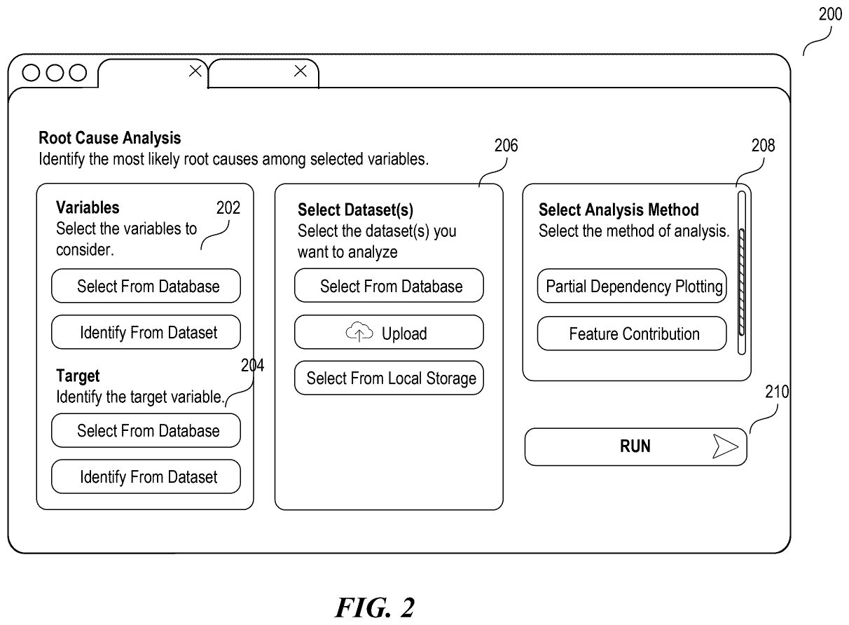

FIG. 2 illustrates an exemplary user interface 200, e.g., of user device 150, at which a user can input a request for identifying one or more variables as principal drivers of change for a value of interest, in accordance with one or more embodiments of this disclosure. For example, in section 206 of exemplary user interface 200, the user may select one or more datasets to analyze to identify a root cause for a change in some value of interest, e.g., housing cost. In some examples, the user may select a baseline dataset (and/or identifier thereof), including samples from before the exhibited change, and the user may also select an updated dataset (and/or identifier thereof) which includes samples that exhibit a change in the value of interest as compared to the baseline dataset. Alternatively, or additionally, the user may select a single dataset which may be partitioned or divided to analyze a difference in a value of interest between the partitioned subsets of the single dataset. As illustrated in FIG. 2, the user may choose to select any combination of the datasets from a remote database (e.g., database 140), by uploading to the interface (e.g., by clicking and dragging), or selecting from local storage (e.g., local memory).

According to some examples, the user may identify the set of variables and/or the target value of interest (e.g., the value exhibiting the change or shift) to analyze as well. In some examples, the user may select the set of variables and/or the target value of interest through section 202 and section 204, respectively. The user may select the variables from the database to analyze, e.g., by selecting via a user selection from a superset of variables. For example, the user interface may identify all variables listed in the datasets and the user may select a smaller subset of the variables that they would like to be analyzed specifically. By enabling user selection, processing power may be saved. Alternatively, or additionally, the user may choose to automatically detect the variables based on the dataset(s) (e.g., use all variables that are automatically detected). Similarly, the user may select, e.g., via user selection, which of the variables (e.g., detected automatically from the dataset) should be analyzed as the value of interest.

In some examples, the user may similarly specify the type of analysis method they would like to use in order to identify the root cause (e.g., identify variables that have a causal effect on the change observed in the target variable between datasets) via section 208. For example, as described herein, the root cause analysis system 110 may utilize one or more techniques to identify variables as principal drivers of change for a value of interest due to data drift.

In some examples, after the user has made the selections in sections, 202, 204, 206, and/or 208, the user may select box 210 to execute the root cause analysis.

In a first technique (e.g., “feature contribution”), the root cause analysis system 110 may utilize feature contributions (e.g., average feature contributions) to identify the variable(s). By taking the difference in feature contributions between the datasets, the system may identify specific contributions by each to identify those variables that are key drivers in a population shift. FIG. 1B shows a root cause analysis system 180 for identifying one or more variables as principal drivers of change for a value of interest using feature contributions, in accordance with one or more embodiments of this disclosure. Similarly, the user may select a second technique, e.g., “partial dependence plotting,” in order to identify the variable(s) as principal drivers of change for a target value of interest due to data drift. Utilizing this method includes the generation of partial dependence plots (PDPs) for each variable. For example, FIG. 1C shows an illustrative system for identifying one or more variables as principal drivers of change for a value of interest using partial dependence plots (PDPs), in accordance with one or more embodiments of this disclosure.

As described herein, FIG. 1B shows a root cause analysis system 180 for identifying one or more variables as principal drivers of change for a value of interest using feature contributions, in accordance with one or more embodiments of this disclosure. The root cause analysis system 180 may have subsystems including communication subsystem 182, model generation subsystem 184, model interpretation subsystem 186, shift determination subsystem 188, and variable determination subsystem 190.

As described herein, the root cause analysis system may obtain a request for identifying one or more variables from a set of variables as principal drivers of change for a target value of interest due to data drift, e.g., from a user device via network 130. The root cause analysis system may receive the request using communication subsystem 182. Communication subsystem 182 may include software components, hardware components, or a combination of both. For example, communication subsystem 182 may include a network card (e.g., a wireless network card and/or a wired network card) that is associated with software to drive the card. Communication subsystem 182 may pass at least a portion of the data included in the request, or a pointer to the data in memory, to other subsystems such as model generation subsystem 184, model interpretation subsystem 186, shift determination subsystem 188, and variable determination subsystem 190.

As described herein, the request may include (1) the set of variables to be analyzed, (2) a baseline dataset, and (3) an updated dataset, where the updated dataset exhibits a change in the value of interest as compared to the baseline dataset. Alternatively, or additionally, the request may instead include a single dataset that may be partitioned, such that a baseline dataset and/or updated dataset may be extracted from the single dataset. For example, the change in the value of interest as compared to the baseline dataset may be a change in the mean target value between datasets. The cause for the shift in the value of interest may be due to change in data (e.g., population shift).

Once the root cause analysis system 180 obtains the set of variables, the baseline dataset, and the updated dataset, the communication subsystem 182 may pass at least a portion of the data, or a pointer to the data in memory, to the model generation subsystem 184. The model generation subsystem 184 may be configured to model the relationships between the target value of interest and the features (e.g., variables). For example, the model generation subsystem may utilize the datasets to model the relationship between the target value of interest and drivers (e.g., features, variables) on the baseline dataset using a machine learning model such as Extreme Gradient Boosting (XGBoost) to obtain a base model. Similarly, the model generation subsystem may utilize the datasets to model the relationship between the target value of interest and drivers on the updated dataset to obtain an updated model. The output of each of the generated models may be a value for the target value of interest, while the inputs may be values for each of the variables.

In particular, XGBoost operates by constructing an ensemble of decision trees, where each tree is built sequentially. Initially, a base decision tree may be created, and its predictions may be used to calculate the errors or residuals between the predicted and actual values of the target variable. Subsequent decision trees are then constructed to correct the errors made by the previous ones. This iterative process may continue until a predefined stopping criterion is met or a specified number of trees are built.

Once the model generation subsystem 184 is used to generate a baseline model and the updated model which model the relationship between the target value of interest and the set of variables using the baseline dataset and the updated dataset, respectively, model generation subsystem 184 may pass the model parameters, or a pointer to the data in memory, of each of the models to model interpretation subsystem 186. The model generation subsystem 184 may also, according to some embodiments, pass the model parameters, or a pointer to the data in memory, to the communication subsystem 182, which may be configured to transmit and store the parameters in a remote database for future reference (e.g., database 140). Similarly, the communication subsystem 182 may pass the updated and baseline datasets, or a pointer to the data in memory, to the model interpretation subsystem 186.

The model interpretation subsystem 186 may use the model parameters of each of the baseline model and the updated model to explain the updated and baseline datasets. In particular, the model interpretation subsystem 186 may process the baseline model using the baseline dataset with a model interpretability method to obtain a first matrix and process the baseline model using the updated dataset with the model interpretability method to obtain a second matrix, wherein each matrix comprises quantitative measures of a contribution of each variable in the set of variables to the value of interest for each sample. Similarly, the model interpretation subsystem 186 may process the baseline model using the updated dataset with the model interpretability method to obtain a third matrix and process the updated model using the updated dataset with the model interpretability method to obtain a fourth matrix.

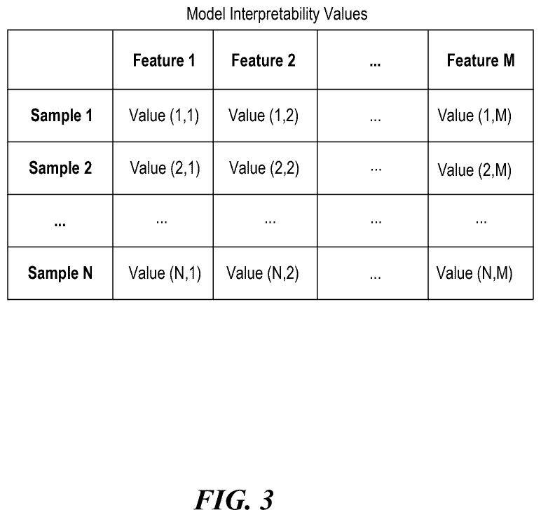

According to some examples, the subsystem may use a method for explainability such as SHapley Additive explanations (SHAP) to explain each model on each dataset. The resultant matrix may include a two-dimensional (2D) matrix of feature contributions for each sample in the dataset. For example, FIG. 3 illustrates an exemplary data structure of model interpretability values, e.g., a two-dimensional (2D) matrix of feature contributions, in accordance with one or more embodiments of this disclosure. In some examples, the rows represent the samples and columns represent the features, e.g., variables. Each row contains contributions of features in bringing the model output (target value) from the average value (on the baseline dataset) to the target value for the relevant sample. For example, “Value (2,1)” of FIG. 3 may represent a value indicative of the contribution of feature 1 (e.g., variable 1 from the set of M variables) for the target value of sample 2.

Each row may contain contributions of features in bringing the model output (target value) from the average value (on the base dataset) to the target value for the relevant sample, e.g., as represented in the following equation:

$${\sum }_{f = 1}^{M} {s}_{i f} = {t}_{i} - {mean}_{i} ( {t}_{i} )$$

In the above equation, tᵢ represents the target value for the ith sample and s_{if} represents the feature contribution (e.g., Shapley value) for the ith sample (e.g., row) and fth feature (e.g., column). For example, the mean target shift may be defined by the equation E(y_{U})−E(y_{B}), where y_{B} represents the target value in samples of the baseline dataset and y_{U} represents the target value in samples of the updated dataset. The target value (y_{B}) in samples of the baseline dataset can be modeled as a function of variables represented herein as (f_{B}(X_{B})) and the target value (y_{U}) in samples of the updated dataset can be modeled as a function of variables represented herein as (f_{U}(X_{U})). Through substitution and decomposition, the mean target shift can be defined as the sum of E(f_{B}(X_{U}))−E(f_{B}(X_{B})), representing population shift, and E(f_{U}(X_{U}))−E(f_{B}(X_{U})), representing performance change (e.g., change of the relationship between the target and features).

The population shift can then be denoted as Eq. 1 below, which can further be simplified as Eq. 2, also provided below, where N_{U} represents the number of samples in the updated dataset, N_{B} represents the number of samples in the baseline dataset, M represents the number of features, and

$${mean}_{j} ( {s}_{j f}^{B} )$$

represents the average over samples of a specific feature for the baseline dataset.

$$\frac{1}{{N}_{U}} {\sum }_{j = 1}^{{N}_{U}} [ {\sum }_{f = 1}^{M} {s}_{jf}^{B} - mean ( {f}_{B} ( {x}_{B} ) ) ] - \frac{1}{{N}_{B}} {\sum }_{i = 1}^{{N}_{B}} [ {\sum }_{f = 1}^{M} {s}_{if}^{B} - mean ( {f}_{B} ( {x}_{B} ) ) ] , \qquad Eq . 1$$

$${\sum }_{f = 1}^{M} [ \frac{1}{{N}_{U}} {\sum }_{j = 1}^{U} {s}_{jf}^{B} - \frac{1}{N B} {\sum }_{\dot{l} = 1}^{{N}_{B}} {s}_{i f}^{B} ] = {\sum }_{f = 1}^{M} [ {mean}_{j} ( {s}_{j f}^{B} ) - {mean}_{i} ( {s}_{if}^{B} ) ] \qquad Eq . 2$$

According to some embodiments, the mean shift (e.g., change) in the target value of interest may be defined as the sum of the population shift value. When a user requests to identify the root cause of the change in the target value, the system may compute the population shift using Eq. 2. For example, the model interpretation subsystem 186 may generate and pass the feature contribution matrices (e.g., SHAP value matrices), or a pointer to the data in memory, to the shift determination subsystem 188, which may be configured to compute population shift values by computing an absolute difference between each of a plurality of row averages of feature contribution matrices, as shown in Eq. 2.

In particular, the population change representing a data shift may be computed by first processing the baseline model using the baseline dataset with a model interpretability method to obtain a first matrix and processing the baseline model using the updated dataset with the model interpretability method to obtain a second matrix, wherein each matrix comprises quantitative measures of a contribution of each variable in the set of variables to the value of interest for each sample. As described herein, these first and second matrices may be computed at model interpretation subsystem 186 and may be passed to the shift determination subsystem 188. The shift determination subsystem 188 may then compute the population change value by computing an absolute difference between row averages of the first matrix and corresponding row averages of the second matrix.

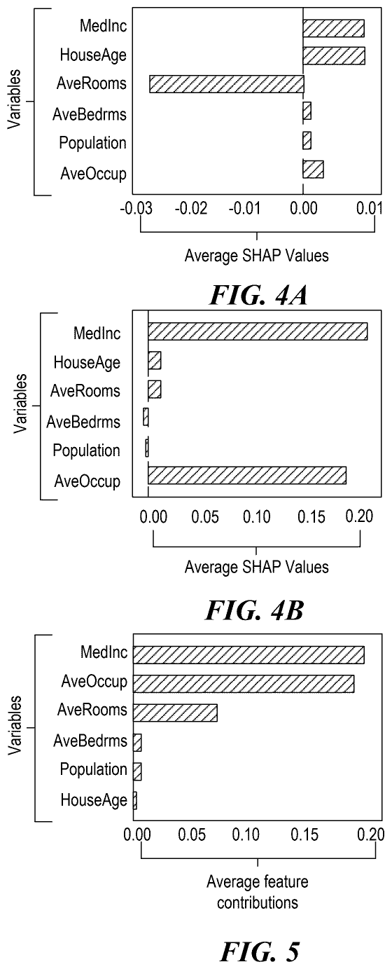

For example, FIG. 4A illustrates an exemplary graph illustrating average feature contribution values for the set of features generated by aggregating model interpretability values obtained by processing the baseline model using the baseline dataset, in accordance with one or more embodiments of this disclosure. For example, the model generation subsystem 184 may generate the baseline model, e.g., using the baseline dataset and pass the parameters of the baseline model for processing at the model interpretation subsystem 186. Model interpretation subsystem 186 may then use explainability techniques such as SHAP to generate a feature contribution matrix for the baseline model using the baseline dataset. The feature contribution matrix may be a data structure such as the data structure of FIG. 3. For each feature, e.g., “MedInc” (i.e., median income), “HouseAge” (i.e., age of the house in years), “AveRooms” (i.e., average number of rooms in the house), “AveBedrms” (i.e., average number of bedrooms in the house), “Population” (i.e., population of the town in which the house is located), “AveOccup” (i.e., the average number of occupants in the house), the shift determination subsystem may calculate the average population change by calculating the average value of the feature over all samples (e.g., samples 1-N).

FIG. 4B illustrates an exemplary graph illustrating average feature contribution values for the set of features generated by aggregating model interpretability values obtained by processing the baseline model using the updated dataset, in accordance with one or more embodiments of this disclosure. For example, the model generation subsystem 184 may generate the baseline model, e.g., using the baseline dataset and pass the parameters of the baseline model for processing at the model interpretation subsystem 186. Model interpretation subsystem 186 may then use explainability techniques such as SHAP to generate a feature contribution matrix for the baseline model using the updated dataset (e.g., as opposed to the baseline dataset in FIG. 4A). The feature contribution matrix may be a data structure such as the data structure of FIG. 3. For each feature, e.g., “MedInc” (i.e., median income), “HouseAge” (i.e., age of the house in years), “AveRooms” (i.e., average number of rooms in the house), “AveBedrms” (i.e., average number of bedrooms in the house), “Population” (i.e., population of the town in which the house is located), “AveOccup” (i.e., the average number of occupants in the house), the shift determination subsystem may calculate the average population change by calculating the average value of the feature over all samples (e.g., samples 1-N).

FIG. 5 illustrates an exemplary population shift graph illustrating an absolute difference between the average feature contribution values from the exemplary graph of FIGS. 4A-4B, in accordance with one or more embodiments of this disclosure. For example, in order to calculate the population change value of each feature (e.g., variable), the shift determination subsystem may then compute the absolute difference between the row averages, e.g., as illustrated in FIGS. 4A and 4B. In some examples, mean target residuals may be subsequently added to the absolute difference. Taking, for example, the feature “MedInc” (i.e., median income), the population change of this feature can be calculated by taking the absolute difference of the average feature contribution of the feature over samples in the baseline dataset represented in FIG. 4A and the average feature contribution of the feature over samples in the updated dataset represented in FIG. 4B. As shown in FIG. 5, “MedInc” is the feature having the largest such absolute value, showing that the feature contribution for this feature has had the most drastic change between the two datasets, and as such, is the feature having the largest population change, e.g., the largest shift in relationship between the target value of home price and the feature, median income.

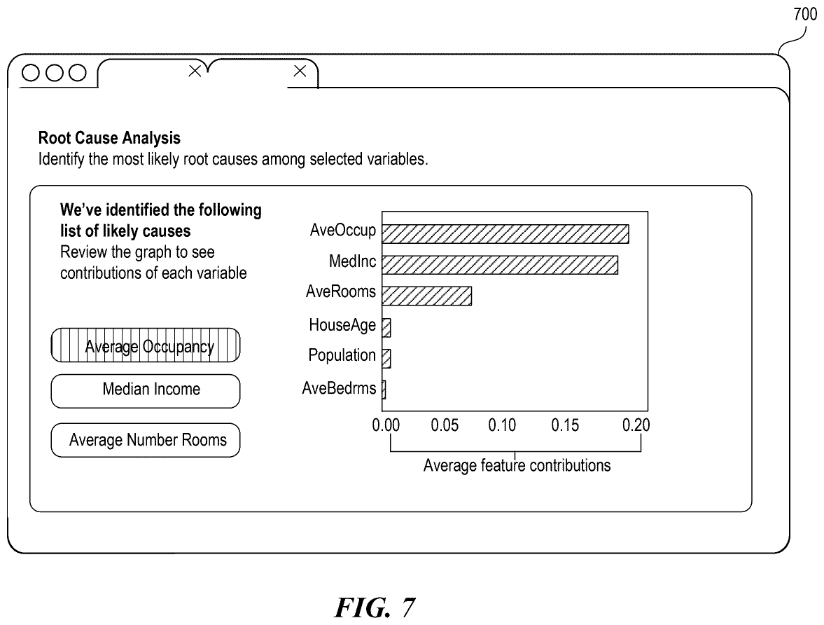

The shift determination subsystem 188 may pass the population change values of each feature, or a pointer to the data in memory, to the variable determination subsystem 190. The variable determination subsystem may identify the features having the largest population change values, or values having at least a threshold population change. The identified features may be stored in memory or transmitted via the communication subsystem, e.g., to a user device, so that they may be used in decision making by other systems or viewed by a user at a graphical interface, e.g., as described further in relation with FIG. 7.

As described herein, rather than using the first technique, or in addition to using the first technique, the user may select a second technique, e.g., “partial dependence plotting,” in order to identify the variable(s) as principal drivers of change for a value of interest due to data drift. For example, the user may specify “partial dependence plotting” as the type of analysis method they would like to use in order to identify the root cause via section 208 of exemplary user interface 200.

Utilizing this method includes the generation of partial dependence plots (PDPs) for each variable. For example, FIG. 1C shows a root cause analysis system 160 for identifying one or more variables as principal drivers of change for a value of interest using partial dependence plots (PDPs), in accordance with one or more embodiments of this disclosure. In some examples, the root cause analysis system 110 may include any combination of subsystems from each of the systems of FIG. 1B and FIG. 1C. The root cause analysis system 160 may include subsystems such as communication subsystem 162, model generation subsystem 164, plot generation subsystem 168, comparison subsystem 170, and/or variable determination subsystem 172.

As described herein, the root cause analysis system may obtain a request for identifying one or more variables from a set of variables as principal drivers of change for a value of interest, e.g., from a user device via network 130. The root cause analysis system 160 may receive the request using communication subsystem 162. Communication subsystem 162 may include software components, hardware components, or a combination of both. For example, communication subsystem 162 may include a network card (e.g., a wireless network card and/or a wired network card) that is associated with software to drive the card. Communication subsystem 162 may pass at least a portion of the data included in the request, or a pointer to the data in memory, to other subsystems.

The request may include (1) the set of variables to be analyzed, (2) a baseline dataset, and (3) an updated dataset, where the updated dataset exhibits a change in the value of interest as compared to the baseline dataset. Alternatively, or additionally, the request may instead include a single dataset that may be partitioned, such that a baseline dataset and/or updated dataset may be extracted from the single dataset. For example, the change in the value of interest as compared to the baseline dataset may be a change in the mean target value between datasets. The cause for the shift in the value of interest may be due to change in data (e.g., population shift) or change in relationships (e.g., performance change).

Once the root cause analysis system 160 obtains the set of variables, the baseline dataset, and the updated dataset, the communication subsystem 162 may pass at least a portion of the data, or a pointer to the data in memory, to the model generation subsystem 164. The model generation subsystem 164 may be configured to model the relationships between the target value of interest and the features (e.g., variables). For example, the model generation subsystem may utilize the datasets to model the relationship between the target value of interest and drivers (e.g., features, variables) on the baseline dataset using a machine learning model such as Extreme Gradient Boosting (XGBoost) to obtain a base model. Similarly, the model generation subsystem may utilize the datasets to model the relationship between the target value of interest and drivers on the updated dataset to obtain an updated model. The output of each of the generated models may be a value for the target value of interest, while the inputs may be values for each of the variables.

Once the model generation subsystem 164 is used to generate a baseline model and the updated model which model the relationship between the target value of interest and the set of variables using the baseline dataset and updated dataset, respectively, model generation subsystem 164 may pass the model parameters, or a pointer to the data in memory, of each of the models to plot generation subsystem 168. The model generation subsystem 164 may also, according to some embodiments, pass the model parameters, or a pointer to the data in memory, to the communication subsystem 162, which may be configured to transmit and store the parameters in a remote database for future reference (e.g., database 140). Similarly, the communication subsystem 162 may pass the updated and baseline datasets, or a pointer to the data in memory, to the plot generation subsystem 168.

The plot generation subsystem may generate partial dependence plots for each feature based on each of the baseline model and the updated model. For example, plotting a partial dependence plot (PDP) for a model may include creating a graphical representation that illustrates how a specific driver variable or feature influences the predictions made by the model while keeping all other variables constant.

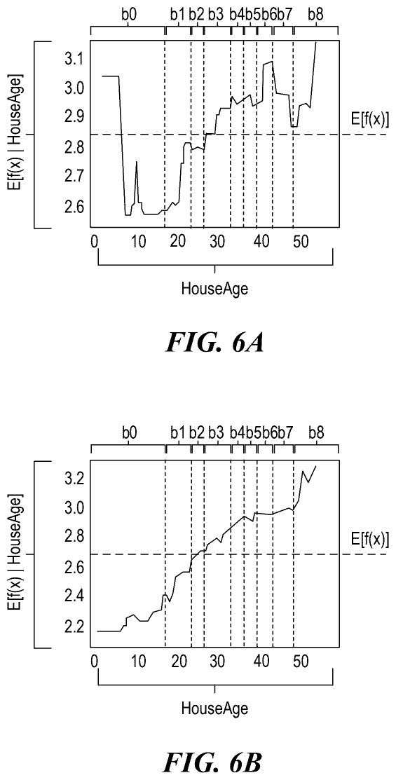

For example, FIG. 6A illustrates an exemplary partial dependence plot (PDP) illustrating the relationship between a variable of the set of variables and the value of interest in the baseline dataset, in accordance with one or more embodiments of this disclosure. In the example of FIG. 6A, the partial dependence plot for the feature “HouseAge” (i.e., age of the house in years) is illustrated. The x-axis shows the age of the house in years, while the y-axis shows “E[f(x)|HouseAge]”, that is, the expected cost of the house given a certain HouseAge value based on the baseline model.

FIG. 6B illustrates an exemplary partial dependence plot (PDP) illustrating the relationship between a variable of the set of variables and the value of interest in the updated dataset, in accordance with one or more embodiments of this disclosure. In the example of FIG. 6B, the partial dependence plot for the feature “HouseAge” (i.e., age of the house in years) is illustrated. The x-axis shows the age of the house in years, while the y-axis shows “E[f(x)|HouseAge]”, that is, the expected cost of the house given a certain HouseAge value based on the updated model.

The plot generation subsystem 168 may pass each generated plot for each variable to the comparison subsystem 170. Comparison subsystem 170 may compare PDPs of baseline and updated models for each variable of the set of variables. The system can then identify features with significantly different feature-target relationships. The system may also further decompose the features into deciles (e.g., 10:90 quantiles) to find the key segments responsible for performance change. The difference between the two plots over each segment can be quantized and sorted to find the segments with highest differences. For example, the different deciles are represented in FIG. 6A and FIG. 6B as b₀, b₁, b₂, b₃, b₄, b₅, b₆, b₇, and b₈. The comparison subsystem 170 may compare each of the values in the different deciles between the two PDPs of each feature. For example, for the feature “HouseAge” the comparison subsystem 170 may compare values from b₀ of FIG. 6A and b₀ of FIG. 6B and do the same for deciles b₁, b₂, b₃, b₄, b₅, b₆, b₇, and b₈. The compared values may be passed, or a pointer to the data in memory may be passed to variable determination subsystem 172. Based on segments having the largest differences among different features, the variable determination subsystem 172 may identify the features having the largest performance change, or values having at least a threshold performance change. The identified features may be stored in memory or transmitted via the communication subsystem, e.g., to a user device, so that they may be used in decision making by other systems or viewed by a user at a graphical interface, e.g., as described further in relation with FIG. 7.

As described herein, the identified root causes may be used by systems to perform other actions such as prevention of similar events or mitigation of events when they are recognized. For example, in risk management or investment analysis, root cause analysis may be used to identify when undesired events occur such as depreciation in investment value (e.g., as a target value of interest) or other undesired performance in market fluctuations, credit risks, and/or operational failures. In such examples, parameters may be monitored to identify when such changes occur, and which parameters cause such behavior and/or otherwise have contributory effect on the changes. Similarly, positive events such as appreciation in investment value can be monitored and a system may use parameter values to recommend certain actions over others. For example, the system may identify that when housing costs fluctuate by 10%, investments in technology often go up as a result of such fluctuation. When the system identifies such fluctuation, the system may recommend a user to invest in technology, for example. In a similar example, such systems can also be applied to fraud detection and prevention. For example, the system may identify parameters that have contributory effect with fraud and use those parameters to automatically set threshold values to monitor, which, when exceeded (e.g., or not met) may cause the system to perform actions, such as to block a user from performing actions like accessing their account, etc.

FIG. 7 is an exemplary graphical interface 700 identifying one or more variables as principal drivers of change for a value of interest, in accordance with one or more embodiments of this disclosure. For example, based on performing one or more root cause analysis techniques as described herein, the root cause analysis system may identify one or more features (e.g., variables) that are the likely cause of the shift in the target value of interest. The graphical interface may also show average feature contributions or PDPs as described herein so that the user may have specific data regarding specific segments and features with the most influence on the shift in target value of interest.

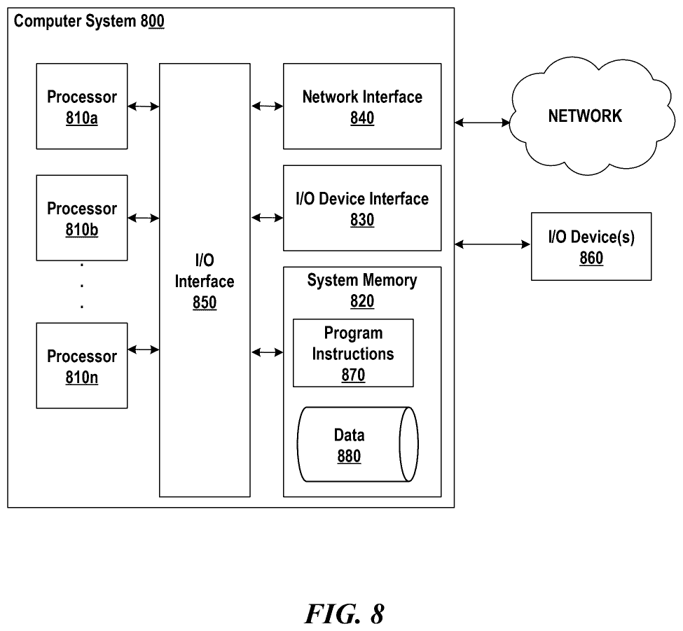

FIG. 8 shows an example computing system that may be used in accordance with some embodiments of this disclosure. In some instances, computing system 800 is referred to as a computer system 800. A person skilled in the art would understand that those terms may be used interchangeably. The components of FIG. 8 may be used to perform some, or all operations discussed in relation to the previous figures. Furthermore, various portions of the systems and methods described herein may include or be executed on one or more computer systems similar to computing system 800. Further, processes and modules described herein may be executed by one or more processing systems similar to that of computing system 800.

Computing system 800 may include one or more processors (e.g., processors 810a-810n) coupled to system memory 820, an input/output (I/O) device interface 830, and a network interface 840 via an I/O interface 850. A processor may include a single processor, or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 800. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 820). Computing system 800 may be a uni-processor system including one processor (e.g., processor 810a), or a multi-processor system including any number of suitable processors (e.g., 810a-810n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field-programmable gate array) or an ASIC (application-specific integrated circuit). Computing system 800 may include a plurality of computing devices (e.g., distributed computer systems) to implement various processing functions.

I/O device interface 830 may provide an interface for connection of one or more I/O devices 860 to computer system 800. I/O devices may include devices that receive input (e.g., from a user) or output information (e.g., to a user). I/O devices 860 may include, for example, a graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 860 may be connected to computer system 800 through a wired or wireless connection. I/O devices 860 may be connected to computer system 800 from a remote location. I/O devices 860 located on remote computer systems, for example, may be connected to computer system 800 via a network and network interface 840.

Network interface 840 may include a network adapter that provides for connection of computer system 800 to a network. Network interface 840 may facilitate data exchange between computer system 800 and other devices connected to the network. Network interface 840 may support wired or wireless communication. The network may include an electronic communication network, such as the Internet, a local area network (LAN), a wide area network (WAN), a cellular communications network, or the like.

System memory 820 may be configured to store program instructions 870 or data 880. Program instructions 870 may be executable by a processor (e.g., one or more of processors 810a-810n) to implement one or more embodiments of the present techniques. Program instructions 870 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program may be deployed to be executed on one or more computer processors located locally at one site or distributed across multiple remote sites and interconnected by a communication network.

System memory 820 may include a tangible program carrier having program instructions stored thereon. A tangible program carrier may include a non-transitory computer-readable storage medium. A non-transitory computer-readable storage medium may include a machine-readable storage device, a machine-readable storage substrate, a memory device, or any combination thereof. A non-transitory computer-readable storage medium may include non-volatile memory (e.g., flash memory, ROM, PROM, EPROM, EEPROM memory), volatile memory (e.g., random access memory (RAM), static random-access memory (SRAM), synchronous dynamic RAM (SDRAM)), bulk storage memory (e.g., CD-ROM and/or DVD-ROM, hard drives), or the like. System memory 820 may include a non-transitory computer-readable storage medium that may have program instructions stored thereon that are executable by a computer processor (e.g., one or more of processors 810a-810n) to cause the subject matter and the functional operations described herein. A memory (e.g., system memory 820) may include a single memory device and/or a plurality of memory devices (e.g., distributed memory devices).

I/O interface 850 may be configured to coordinate I/O traffic between processors 810a-810n, system memory 820, network interface 840, I/O devices 860, and/or other peripheral devices. I/O interface 850 may perform protocol, timing, or other data transformations to convert data signals from one component (e.g., system memory 820) into a format suitable for use by another component (e.g., processors 810a-810n). I/O interface 850 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 800, or multiple computer systems 800 configured to host different portions or instances of embodiments. Multiple computer systems 800 may provide for parallel or sequential processing/execution of one or more portions of the techniques described herein.

Those skilled in the art will appreciate that computer system 800 is merely illustrative and is not intended to limit the scope of the techniques described herein. Computer system 800 may include any combination of devices or software that may perform or otherwise provide for the performance of the techniques described herein. For example, computer system 800 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, a Global Positioning System (GPS), or the like. Computer system 800 may also be connected to other devices that are not illustrated or may operate as a stand-alone system. In addition, the functionality provided by the illustrated components may, in some embodiments, be combined in fewer components, or distributed in additional components. Similarly, in some embodiments, the functionality of some of the illustrated components may not be provided, or other additional functionality may be available.

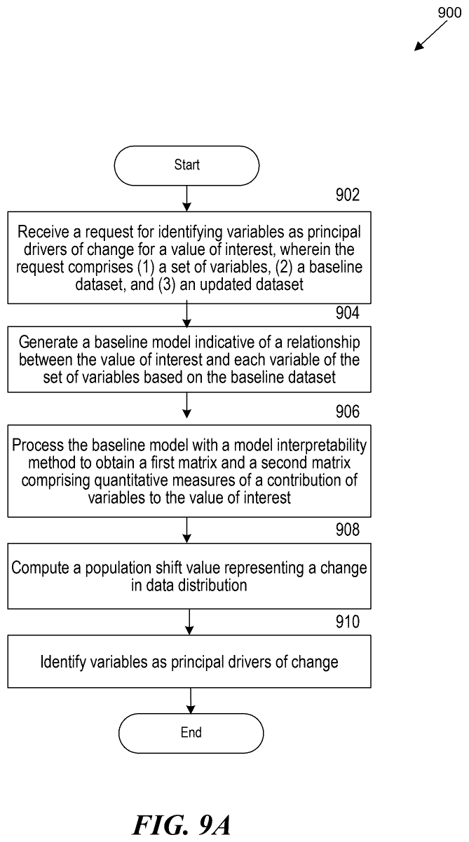

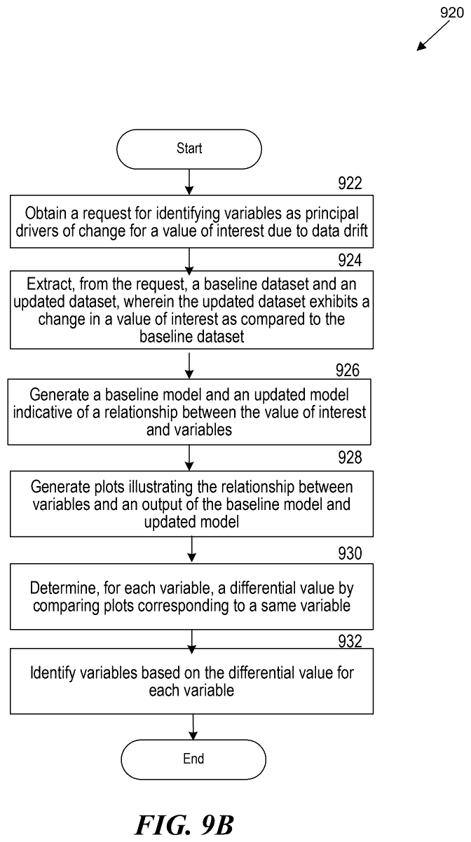

FIG. 9A is a flowchart of operations 900 for identifying one or more variables as principal drivers of change for a value of interest using feature contributions, in accordance with one or more embodiments of this disclosure. The operations of FIG. 9A may use components described in relation to FIG. 8. In some embodiments, root cause analysis system 110 may include one or more components of computer system 800.

At 902, root cause analysis system 110 receives a request for identifying variables as principal drivers of change for a value of interest due to data drift, wherein the request comprises (1) the set of variables, (2) a baseline dataset, and (3) an updated dataset. For example, the root cause analysis system 110 receives, from a user (e.g., via user device), a request for identifying one or more variables from a set of variables (e.g., selected as described herein) as principal drivers of change for a value of interest due to data drift, wherein the request comprises (1) the set of variables, (2) a baseline dataset, and (3) an updated dataset. The updated dataset may exhibit a change in the value of interest as compared to the baseline dataset. In some examples, the system may obtain a user selection of the set of variables for analysis from a superset of variables. In one example, the user may send a request with a baseline dataset of home prices in 2010 including values for variables such as number of rooms, square footage, etc. and an updated dataset of home prices in 2011 with values for the same variables.

At 904, root cause analysis system 110 generates a baseline model indicative of a relationship between the value of interest and each variable of the set of variables based on the baseline dataset. Root cause analysis system 110 may use one or more processors 810a, 810b, and/or 810n to perform the generation. For example, the system may generate the models using one or more machine learning models (e.g., using XGBoost) and the baseline model may be indicative of a relationship between the value of interest and each variable of the set of variables based on the baseline dataset. In one example, the value of interest may be the price of the home, and the root cause analysis system 110 may generate a baseline model between the home price and the number of rooms, a baseline model between the home price and the square footage, etc. using the baseline dataset of home prices in 2010.

At 906, root cause analysis system 110 processes the baseline model with a model interpretability method to obtain a first matrix and a second matrix comprising quantitative measures of a contribution of variables to the value of interest. For example, the system may process the baseline model using the baseline dataset with a model interpretability method to obtain a first matrix and processing the baseline model using the updated dataset with the model interpretability method to obtain a second matrix. According to some examples, each matrix comprises quantitative measures of a contribution of each variable in the set of variables to the value of interest for each sample. Further, the first matrix and second matrix may include two-dimensional matrices comprising rows and columns, where each row of the first matrix represents a sample from the baseline dataset and each column represents a variable from the set of variables. In the example from step 902 and step 904, the root cause analysis system 110 may process the baseline model (e.g., the baseline model between the home price and the number of rooms) with a model interpretability method to obtain two matrices having measures that identify the contribution of variables such as the number of rooms, square footage, etc. to the home price in 2010.

At 908, the root cause analysis system 110 computes a population shift value representing a change in data distribution. For example, the system may use one or more processors 810a-810n to compute a population change value. The system may perform the computation by computing an absolute difference between each of a plurality of row averages of the first matrix and a corresponding plurality of row averages of the second matrix. In the example from step 902 and step 904, the root cause analysis system 110 may compute the absolute difference between a plurality of row averages of each of the two matrices.

At 910, the root cause analysis system 110 identifies variables as principal drivers of change for a value of interest. For example, root cause analysis system 110 may identify, from the set of variables, the one or more variables as principal drivers of change for a value of interest based on absolute differences between the plurality of row averages. In the example from step 902 and step 904, based on the absolute differences that are largest, the system can determine which variable is a principal driver of change (e.g., number of rooms, square footage, etc.).

Additionally, the root cause analysis system may generate one or more commands to display the identified variables to a user at a remote device, e.g., via a graphical display as described in reference to FIG. 7. For example, the system may generate a graphical representation of the difference between the plurality of row averages, e.g., such as the graph of FIG. 5 and further generate a command for displaying, to a user, the graphical representation. Additionally or alternatively, if the model performance is determined to be poor (e.g., does not exceed a minimum threshold for model performance), this may be indicative that the chosen set of variables are not suitable for modeling the value of interest, and the system may generate a command to prompt the user to select a new set of features, e.g., from a superset of features.

FIG. 9B is a flowchart of operations 920 for identifying one or more variables as principal drivers of change for a value of interest using partial dependence plots (PDPs), in accordance with one or more embodiments of this disclosure. The operations of FIG. 9B may use components described in relation to FIG. 8. In some embodiments, root cause analysis system 110 may include one or more components of computer system 800.

At 922, root cause analysis system 110 obtains a request for identifying variables as principal drivers of change for a value of interest due to data drift. For example, the root cause analysis system 110 may obtain, e.g., from a remote device, a request for identifying one or more variables from a set of variables as principal drivers of change for a value of interest. The request may include (1) the set of variables and (2) data comprising samples indicating the value of interest for specific values for the set of variables. In some examples, the system may obtain a user selection of the set of variables for analysis from a superset of variables. For example, the request may include a subset from a larger set of variables that may be indicative of change in home price, such as number of rooms and square footage from a larger set including number of rooms, square footage, lot size, number of bathrooms, etc. The request may also include the value of interest, e.g., home price, as well as values for the number of rooms and square footage.

At 924, root cause analysis system 110 may extract, from the request, a baseline dataset and an updated dataset, where the updated dataset exhibits a change in a value of interest as compared to the baseline dataset. Root cause analysis system 110 may use one or more processors 810a, 810b, and/or 810n to perform the extraction. For example, the system may extract a baseline dataset which shows home prices that are lower, and an updated dataset, which shows home prices that have shifted, e.g., to be higher or lower.

At 926, the system may generate a baseline model and an updated model indicative of a relationship between the value of interest and variables. For example, the system may generate, using one or more machine learning models (e.g., XGBoost), a baseline model indicative of a relationship between the value of interest and each variable of the set of variables based on the baseline dataset and an updated model indicative of a relationship between the value of interest and each variable of the set of variables based on the updated dataset. In one example, the value of interest may be the price of the home, and the root cause analysis system 110 may generate a baseline model between the home price and the number of rooms, a baseline model between the home price and the square footage, etc. using the baseline dataset of home prices in 2010.

At 928, root cause analysis system 110 generates plots illustrating the relationship between variables and the value of interest in the baseline dataset and in the updated dataset. For example, the system may generate (1) a first plurality of partial dependence plots, wherein each partial dependence plot of the first plurality of partial dependence plots illustrates the relationship between a variable of the set of variables and the value of interest in the baseline dataset, and (2) a second plurality of partial dependence plots, wherein each partial dependence plot of the second plurality of partial dependence plots illustrates the relationship between the variable and the value of interest in the updated dataset. According to some examples, the first plurality of plots comprises partial dependence plots, wherein a first axis of each plot identifies values of a variable, and a second axis of each plot identifies the value of interest in the baseline dataset for corresponding values of the variable. In some examples, the second plurality of plots comprises partial dependence plots, wherein a first axis of each plot identifies values of a variable, and a second axis of each plot identifies the value of interest in the updated dataset for corresponding values of the variable.

At 930, the root cause analysis system 110 determines, for each variable, a differential value by comparing plots corresponding to a same variable. For example, the system may use one or more processors 810a-810n to determine, for each variable of the set of variables, a differential value by comparing partial dependence plots corresponding to a same variable of the set of variables from the first plurality of partial dependence plots and second plurality of partial dependence plots. At 932, the system may identify variables as principal drivers of change for a value of interest, based on the differential value for each variable. For example, based on the differential value that are largest, the system can determine which variable is a principal driver of change (e.g., number of rooms, square footage, etc.).

In some examples, the system may be enabled to identify, at a more granular level, what value ranges for the features have a causal effect or otherwise contributory effect on the value of interest or simply as principal drivers of change for a value of interest due to data drift. For example, the system may split the samples of the baseline and updated dataset into deciles, or other partitions to obtain segments. For example, the system may obtain a first set of segments based on partitioning, for a variable of the set of variables, a first corresponding plot of the first plurality of plots and obtain a second set of segments based on partitioning, for the variable of the set of variables, a second corresponding plot of the second plurality of plots. Partitioning the corresponding plots may include identifying deciles based on a distribution of values of the variable on the plots. The system may then determine a set of differential values by comparing corresponding segments of the first set of segments and second set of segments and identify one or more segments corresponding to one or more largest differential values. The system may then generate a command for displaying, to a user, the one or more segments and transmit the command to a remote device.

Additionally, the root cause analysis system may generate one or more commands to display the identified variables to a user at a remote device, e.g., via a graphical display as described in reference to FIG. 7. For example, the system may generate a graphical representation of the differential value for each variable and generate a command for displaying, to a user, the graphical representation. Additionally or alternatively, if the model performance is determined to be poor (e.g., does not exceed a minimum threshold for model performance), this may be indicative that the chosen set of variables are not suitable for modeling the value of interest, and the system may generate a command to prompt the user to select a new set of features, e.g., from a superset of features.

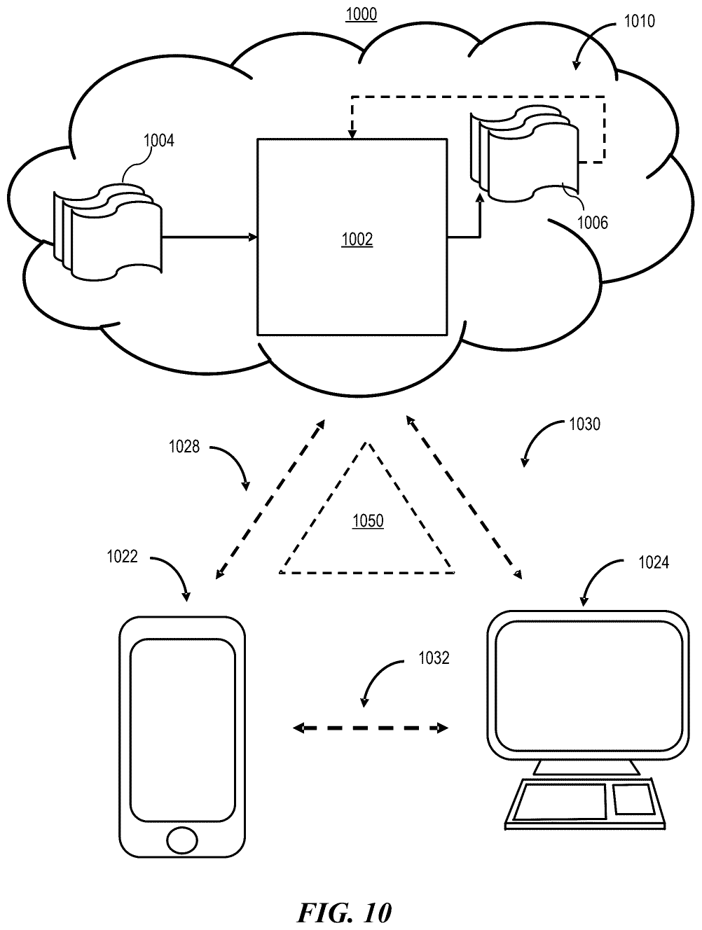

FIG. 10 shows illustrative components for a system used to identify one or more variables as principal drivers of change for a value of interest, in accordance with one or more embodiments. As shown in FIG. 10, system 1000 may include mobile device 1022 and user terminal 1024. While shown as a smartphone and personal computer, respectively, in FIG. 10, it should be noted that mobile device 1022 and user terminal 1024 may be any computing device, including, but not limited to, a laptop computer, a tablet computer, a hand-held computer, and other computer equipment (e.g., a server), including “smart,” wireless, wearable, and/or mobile devices. FIG. 10 also includes cloud components 1010. Cloud components 1010 may alternatively be any computing device as described above, and may include any type of mobile terminal, fixed terminal, or other device.

For example, cloud components 1010 may be implemented as a cloud computing system, and may feature one or more component devices. In one example, the cloud components may include subsystems of root cause analysis system 180 and 160, database 140, and/or user device 150. It should also be noted that system 1000 is not limited to three devices. Users may, for instance, utilize one or more devices to interact with one another, one or more servers, or other components of system 1000. It should be noted, that, while one or more operations are described herein as being performed by particular components of system 1000, these operations may, in some embodiments, be performed by other components of system 1000. As an example, while one or more operations are described herein as being performed by components of mobile device 1022, these operations may, in some embodiments, be performed by components of cloud components 1010. In some embodiments, the various computers and systems described herein may include one or more computing devices that are programmed to perform the described functions. Additionally, or alternatively, multiple users may interact with system 1000 and/or one or more components of system 1000. For example, in one embodiment, a first user and a second user may interact with system 1000 using two different components.

With respect to the components of mobile device 1022, user terminal 1024, and cloud components 1010, each of these devices may receive content and data via input/output (I/O) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 10, both mobile device 1022 and user terminal 1024 include a display upon which to display data (e.g., conversational response, queries, and/or notifications). As described herein, the display may be used to display one or more of the user interfaces described in relation with FIG. 2 and FIG. 7, and may also otherwise be configured to display data such as data described in relation with FIG. 3, FIG. 4A, FIG. 4B, FIG. 5, FIG. 6A, and FIG. 6B, e.g., for user review.

Additionally, as mobile device 1022 and user terminal 1024 are shown as a touchscreen smartphone and a personal computer, respectively, these displays also act as user input interfaces. For example, in the case of FIG. 7, user input such as voice input, cursor movement, or cursor clicks may be used to click through one or more of the identified variables having causal or otherwise contributory effect or as principal drivers of change for a value of interest due to data drift. In the case of FIG. 2, such user input may be used to identify the set of variables for consideration, the target value of interest, the database(s) for use, analysis methods to execute, as well as enable a user to start and stop the execution of such analysis methods.

It should be noted that in some embodiments, the devices may have neither user input interfaces nor displays, and may instead receive and display content using another device (e.g., a dedicated display device such as a computer screen, and/or a dedicated input device such as a remote control, mouse, voice input, etc.). Additionally, the devices in system 1000 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 10 also includes communication paths 1028, 1030, and 1032. In FIG. 1A, one or more paths of the communication paths may be embodied in network 130 between different devices. Communication paths 1028, 1030, and 1032 may include the Internet, a mobile phone network, a mobile voice or data network (e.g., a 5G or LTE network), a cable network, a public switched telephone network, or other types of communications networks or combinations of communications networks. Communication paths 1028, 1030, and 1032 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

As described herein, cloud components 1010 may include root cause analysis system 110, e.g., including one or more subsystems of root cause analysis system 180 and root cause analysis system 160, user device 150, and/or database 140 via network 130. Cloud components 1010 may access data such as from database 140, e.g., via network 130. Cloud components 1010 may include model 1002, which may be a machine learning model, artificial intelligence model, etc. (which may be referred to collectively as “models” herein). Model 1002 may take inputs 1004 and provide outputs 1006. The inputs may include multiple datasets, such as a training dataset and a test dataset. Each of the plurality of datasets (e.g., inputs 1004) may include data subsets related to user data, predicted forecasts and/or errors, and/or actual forecasts and/or errors. In some embodiments, outputs 1006 may be fed back to model 1002 as input to train model 1002 (e.g., alone or in conjunction with user indications of the accuracy of outputs 1006, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., models that model the relationship between the features and the value of the target value of interest).

In a variety of embodiments, model 1002 may update its configurations (e.g., weights, biases, or other parameters) based on the assessment of its prediction (e.g., outputs 1006) and reference feedback information (e.g., user indication of accuracy, reference labels, or other information). In a variety of embodiments, where model 1002 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 1002 may be trained to generate better predictions.

In some embodiments, model 1002 may include an artificial neural network. In such embodiments, model 1002 may include an input layer and one or more hidden layers. Each neural unit of model 1002 may be connected with many other neural units of model 1002. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 1002 may be self-learning and trained, rather than explicitly programmed, and can perform significantly better in certain areas of problem solving, as compared to traditional computer programs. During training, an output layer of model 1002 may correspond to a classification of model 1002, and an input known to correspond to that classification may be input into an input layer of model 1002 during training. During testing, an input without a known classification may be input into the input layer, and a determined classification may be output.

In some embodiments, model 1002 may include multiple layers (e.g., where a signal path traverses from front layers to back layers). In some embodiments, back propagation techniques may be utilized by model 1002 where forward stimulation is used to reset weights on the “front” neural units. In some embodiments, stimulation and inhibition for model 1002 may be more free-flowing, with connections interacting in a more chaotic and complex fashion. During testing, an output layer of model 1002 may indicate whether or not a given input corresponds to a classification of model 1002 (e.g., models that model the relationship between the features and the value of the target value of interest).

In some embodiments, the model (e.g., model 1002) may automatically perform actions based on outputs 1006. In some embodiments, the model (e.g., model 1002) may not perform any actions. The parameters of the model (e.g., model 1002) may be used to generate the feature matrices to identify the feature contributions of each feature on the target value of interest.

System 1000 also includes API layer 1050. API layer 1050 may allow the system to generate summaries across different devices. In some embodiments, API layer 1050 may be implemented on user device 1022 or user terminal 1024. Alternatively or additionally, API layer 1050 may reside on one or more of cloud components 1010. API layer 1050 (which may be a REST or Web services API layer) may provide a decoupled interface to data and/or functionality of one or more applications. API layer 1050 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 1050 may use various architectural arrangements. For example, system 1000 may be partially based on API layer 1050, such that there is strong adoption of SOAP and RESTful Web services, using resources like Service Repository and Developer Portal, but with low governance, standardization, and separation of concerns. Alternatively, system 1000 may be fully based on API layer 1050, such that separation of concerns between layers like API layer 1050, services, and applications are in place.

In some embodiments, the system architecture may use a microservice approach. Such systems may use two types of layers: Front-End Layer and Back-End Layer where microservices reside. In this kind of architecture, the role of the API layer 1050 may provide integration between Front-End and Back-End. In such cases, API layer 1050 may use RESTful APIs (exposition to front-end or even communication between microservices). API layer 1050 may use AMQP (e.g., Kafka, RabbitMQ, etc.). API layer 1050 may use incipient usage of new communications protocols such as gRPC, Thrift, etc.

In some embodiments, the system architecture may use an open API approach. In such cases, API layer 1050 may use commercial or open source API platforms and their modules. API layer 1050 may use a developer portal. API layer 1050 may use strong security constraints applying WAF and DDOS protection, and API layer 1050 may use RESTful APIs as standard for external integration.

The above-described embodiments of the present disclosure are presented for purposes of illustration, and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
A1. A method for identifying one or more variables as principal drivers of change for a value of interest, the method comprising: receiving, from a user, a request for identifying one or more variables from a set of variables as principal drivers of change for a value of interest, wherein the request comprises (1) the set of variables, (2) a baseline dataset, and (3) an updated dataset, wherein the updated dataset exhibits a change in the value of interest as compared to the baseline dataset; generating, using one or more machine learning models, a baseline model indicative of a relationship between the value of interest and each variable of the set of variables based on the baseline dataset; processing the baseline model using the baseline dataset with a model interpretability method to obtain a first matrix and processing the baseline model using the updated dataset with the model interpretability method to obtain a second matrix, wherein each matrix comprises quantitative measures of a contribution of each variable in the set of variables to the value of interest for each sample; computing a population shift value representing a change in data distribution by computing an absolute difference between each of a plurality of row averages of the first matrix and a corresponding plurality of row averages of the second matrix; and identifying, from the set of variables, the one or more variables as principal drivers of change for a value of interest based on absolute differences between the row averages.
A2. Any of the preceding embodiments, further comprising: generating a command for displaying, to a user, the one or more variables; and transmitting the command to a remote device.
A3. Any of the preceding embodiments, further comprising generating, using the one or more machine learning models, an updated model indicative of a relationship between the value of interest and each variable of the set of variables based on the updated dataset.
A4. Any of the preceding embodiments, wherein computing an absolute difference between each of the plurality of row averages of the first matrix and the corresponding plurality of row averages of the second matrix comprises: averaging values of each row of the first matrix to obtain a first plurality of average values, wherein each average value of the first plurality of average values corresponds to an average contribution of a variable to the value of interest in samples of the baseline dataset according to the baseline model; and averaging values of each row of the second matrix to obtain a second plurality of average values, wherein each average value of the second plurality of average values corresponds to an average contribution of a variable to the value of interest in samples of the updated dataset according to the baseline model.
A5. Any of the preceding embodiments, further comprising computing the absolute difference between each average value of the first plurality of average values and a corresponding average value of the second plurality of average values.
A6. Any of the preceding embodiments, further comprising determining the set of variables for analysis from a superset of variables based on the data of the baseline dataset and the updated dataset.
A7. Any of the preceding embodiments, further comprising generating a graphical representation of a difference between each of the plurality of row averages of the first matrix and the corresponding plurality of row averages of the second matrix; and generating a command for displaying, to a user, the graphical representation.
A8. Any of the preceding embodiments, wherein the first matrix and second matrix are two-dimensional matrices comprising rows and columns, each row of the first matrix representing a sample from the baseline dataset and each column representing a variable from the set of variables.
A9. Any of the preceding embodiments, further comprising obtaining a user selection of the set of variables for analysis from a superset of variables.
A10. Any of the preceding embodiments, further comprising: determining a value indicative of model performance of the baseline model; and responsive to determining that the value does not exceed a minimum threshold for model performance, generating a command for prompting a user to select a new set of features from a superset of features.
A11. Any of the preceding embodiments, further comprising transmitting, to a remote server, a request for storing parameters of the baseline model.
A12. A tangible, non-transitory, machine-readable medium storing instructions that, when executed by a data processing apparatus, cause the data processing apparatus to perform operations comprising those of any of embodiments A1-A11.
A13. A system comprising: one or more processors; and memory storing instructions that, when executed by the processors, cause the processors to effectuate operations comprising those of any of embodiments A1-A11.
A14. A system comprising means for performing any of embodiments A1-A11.
A15. A system comprising cloud-based circuitry for performing any of embodiments A1-A11.
B1. A method for identifying one or more variables as principal drivers of change for a value of interest, the method comprising: obtaining a request for identifying one or more variables from a set of variables as principal drivers of change for a value of interest, wherein the request comprises (1) the set of variables and (2) data comprising samples indicating the value of interest for specific values for the set of variables; extracting, from the data, a baseline dataset and an updated dataset, wherein the updated dataset exhibits a change in the value of interest as compared to the baseline dataset; generating, using one or more machine learning models, a baseline model indicative of a relationship between the value of interest and each variable of the set of variables based on the baseline dataset and an updated model indicative of a relationship between the value of interest and each variable of the set of variables based on the updated dataset; generating (1) a first plurality of plots, wherein each plot of the first plurality of plots illustrates the relationship between a variable of the set of variables and the value of interest in the baseline dataset, and (2) a second plurality of plots, wherein each plot of the second plurality of plots illustrates the relationship between the variable and the value of interest in the updated dataset; determining, for each variable of the set of variables, a differential value by comparing plots corresponding to a same variable of the set of variables from the first plurality of plots and second plurality of plots; and identifying, from the set of variables, the one or more variables as principal drivers of change for a value of interest based on the differential value for each variable.
B2. A method for identifying one or more variables as principal drivers of change for a value of interest, the method comprising: obtaining, from a remote device, a request for identifying one or more variables from a set of variables as principal drivers of change for a value of interest, wherein the request comprises (1) the set of variables and (2) data comprising samples indicating the value of interest for specific values for the set of variables; extracting, from the data, a baseline dataset and an updated dataset, wherein the updated dataset exhibits a change in the value of interest as compared to the baseline dataset; generating, using one or more machine learning models, a baseline model indicative of a relationship between the value of interest and each variable of the set of variables based on the baseline dataset and an updated model indicative of a relationship between the value of interest and each variable of the set of variables based on the updated dataset; generating (1) a first plurality of partial dependence plots, wherein each partial dependence plot of the first plurality of partial dependence plots illustrates the relationship between a variable of the set of variables and the value of interest in the baseline dataset, and (2) a second plurality of partial dependence plots, wherein each partial dependence plot of the second plurality of partial dependence plots illustrates the relationship between the variable and the value of interest in the updated dataset; determining, for each variable of the set of variables, a differential value by comparing partial dependence plots corresponding to a same variable of the set of variables from the first plurality of partial dependence plots and second plurality of partial dependence plots; identifying, based on the differential value for each variable, the one or more variables from the set of variables having a largest performance change representative of a change in the relationship between the value of interest and the set of variables; and generating a command for displaying the one or more variables at a remote device.
B3. A method for identifying one or more variables as principal drivers of change for a value of interest, the method comprising: obtaining a request for identifying one or more variables from a set of variables as principal drivers of change for a value of interest, wherein the request comprises (1) the set of variables, (2) a baseline dataset, and (3) an updated dataset, wherein the updated dataset exhibits a change in the value of interest as compared to the baseline dataset; generating, using one or more machine learning models, a baseline model indicative of a relationship between the value of interest and each variable of the set of variables based on the baseline dataset and an updated model indicative of a relationship between the value of interest and each variable of the set of variables based on the updated dataset; generating (1) a first plurality of plots, wherein each plot of the first plurality of plots illustrates the relationship between a variable of the set of variables and the value of interest in the baseline dataset, and (2) a second plurality of plots, wherein each plot of the second plurality of plots illustrates the relationship between the variable and the value of interest in the updated dataset; determining, for each variable of the set of variables, a differential value by comparing plots corresponding to a same variable of the set of variables from the first plurality of plots and second plurality of plots; and identifying, from the set of variables, the one or more variables as principal drivers of change for a value of interest based on the differential value for each variable.
B4. Any of the preceding embodiments, further comprising: obtaining a first set of segments based on partitioning, for a variable of the set of variables, a first corresponding plot of the first plurality of plots; obtaining a second set of segments based on partitioning, for the variable of the set of variables, a second corresponding plot of the second plurality of plots; determining a set of differential values by comparing corresponding segments of the first set of segments and second set of segments; and identifying one or more segments corresponding to one or more largest differential values.
B5. Any of the preceding embodiments, wherein partitioning the first corresponding plot comprises identifying deciles based on a distribution of values of the variable on the first corresponding plot.
B6. Any of the preceding embodiments, further comprising generating a command for displaying, to a user, the one or more segments and transmitting the command to a remote device.
B7. Any of the proceeding embodiments, wherein the first plurality of plots comprises partial dependence plots, wherein a first axis of each plot identifies values of a variable, and a second axis of each plot identifies the value of interest in the baseline dataset for corresponding values of the variable.
B8. Any of the preceding embodiments, wherein the second plurality of plots comprises partial dependence plots, wherein a first axis of each plot identifies values of a variable, and a second axis of each plot identifies the value of interest in the updated dataset for corresponding values of the variable.
B9. Any of the preceding embodiments, further comprising generating a graphical representation of the differential value for each variable and generating a command for displaying, to a user, the graphical representation.
B10. Any of the preceding embodiments, wherein identifying the one or more variables as principal drivers of change for a value of interest based on the differential value for each variable comprises identifying the one or more variables from the set of variables having a largest performance change representative of a change in the relationship between the value of interest and the set of variables.
B11. Any of the preceding embodiments, further comprising obtaining a user selection of the set of variables for analysis from a superset of variables.
B12. Any of the preceding embodiments, further comprising: determining a value indicative of model performance of the baseline model and/or the updated model; and responsive to determining that the value does not exceed a minimum threshold for model performance, generating a command for prompting a user to select a new set of variables from a superset of variables.
B13. Any of the preceding embodiments, further comprising transmitting, to a remote server, a request for storing parameters of the baseline model.
B14. A tangible, non-transitory, machine-readable medium storing instructions that, when executed by a data processing apparatus, cause the data processing apparatus to perform operations comprising those of any of embodiments B1-B13.
B15. A system comprising: one or more processors; and memory storing instructions that, when executed by the processors, cause the processors to effectuate operations comprising those of any of embodiments B1-B13.
B16. A system comprising means for performing any of embodiments B1-B13.
B17. A system comprising cloud-based circuitry for performing any of embodiments B1-B13.

What is claimed is:

1. A system for identifying one or more variables as principal drivers of change for a value of interest, the system comprising:
one or more processors; and
one or more non-transitory, computer-readable media comprising instructions that, when executed by the one or more processors, cause operations comprising:
obtaining, from a remote device, a request for identifying one or more variables from a set of variables as principal drivers of change for a value of interest, wherein the request comprises (1) the set of variables and (2) data comprising samples indicating the value of interest for specific values for the set of variables;
extracting, from the data, a baseline dataset and an updated dataset, wherein the updated dataset exhibits a change in the value of interest as compared to the baseline dataset;
generating, using one or more machine learning models, a baseline model indicative of a relationship between the value of interest and each variable of the set of variables based on the baseline dataset and an updated model indicative of a relationship between the value of interest and each variable of the set of variables based on the updated dataset;
generating (1) a first plurality of partial dependence plots, wherein each partial dependence plot of the first plurality of partial dependence plots illustrates the relationship between a variable of the set of variables and the value of interest in the baseline dataset, and (2) a second plurality of partial dependence plots, wherein each partial dependence plot of the second plurality of partial dependence plots illustrates the relationship between the variable and the value of interest in the updated dataset;
determining, for each variable of the set of variables, a differential value by comparing partial dependence plots corresponding to a same variable of the set of variables from the first plurality of partial dependence plots and the second plurality of partial dependence plots;
identifying, based on the differential value for each variable, the one or more variables from the set of variables having a largest performance change representative of a change in the relationship between the value of interest and the set of variables; and
generating a command for displaying the one or more variables at a remote device.

2. A method for identifying one or more variables as principal drivers of change for a value of interest, the method comprising:
obtaining a request for identifying one or more variables from a set of variables as principal drivers of change for a value of interest, wherein the request comprises (1) the set of variables and (2) data comprising samples indicating the value of interest for specific values for the set of variables;
extracting, from the data, a baseline dataset and an updated dataset, wherein the updated dataset exhibits a change in the value of interest as compared to the baseline dataset;
generating, using one or more machine learning models, a baseline model indicative of a relationship between the value of interest and each variable of the set of variables based on the baseline dataset and an updated model indicative of a relationship between the value of interest and each variable of the set of variables based on the updated dataset;
generating (1) a first plurality of plots, wherein each plot of the first plurality of plots illustrates the relationship between a variable of the set of variables and the value of interest in the baseline dataset, and (2) a second plurality of plots, wherein each plot of the second plurality of plots illustrates the relationship between the variable and the value of interest in the updated dataset;
determining, for each variable of the set of variables, a differential value by comparing plots corresponding to a same variable of the set of variables from the first plurality of plots and the second plurality of plots; and
identifying, from the set of variables, the one or more variables as principal drivers of change for a value of interest based on the differential value for each variable.

3. The method of claim 2, further comprising:
obtaining a first set of segments based on partitioning, for a variable of the set of variables, a first corresponding plot of the first plurality of plots;
obtaining a second set of segments based on partitioning, for the variable of the set of variables, a second corresponding plot of the second plurality of plots;
determining a set of differential values by comparing corresponding segments of the first set of segments and the second set of segments; and
identifying one or more segments corresponding to one or more largest differential values.

4. The method of claim 3, wherein partitioning the first corresponding plot comprises identifying deciles based on a distribution of values of the variable on the first corresponding plot.

5. The method of claim 3, further comprising generating a command for displaying, to a user, the one or more segments and transmitting the command to a remote device.

6. The method of claim 2, wherein the first plurality of plots comprises partial dependence plots, wherein a first axis of each plot identifies values of a variable, and a second axis of each plot identifies the value of interest in the baseline dataset for corresponding values of the variable.

7. The method of claim 2, wherein the second plurality of plots comprises partial dependence plots, wherein a first axis of each plot identifies values of a variable, and a second axis of each plot identifies the value of interest in the updated dataset for corresponding values of the variable.

8. The method of claim 2, further comprising generating a graphical representation of the differential value for each variable and generating a command for displaying, to a user, the graphical representation.

9. The method of claim 2, wherein identifying the one or more variables as principal drivers of change for a value of interest based on the differential value for each variable comprises identifying the one or more variables from the set of variables having a largest performance change representative of a change in the relationship between the value of interest and the set of variables.

10. The method of claim 2, further comprising obtaining a user selection of the set of variables for analysis from a superset of variables.

11. The method of claim 10, further comprising:
determining a value indicative of model performance of the baseline model and/or the updated model; and
responsive to determining that the value does not exceed a minimum threshold for model performance, generating a command for prompting a user to select a new set of variables from a superset of variables.

12. The method of claim 2, further comprising transmitting, to a remote server, a request for storing parameters of the baseline model.

13. One or more non-transitory, computer-readable media comprising instructions recorded thereon that, when executed by one or more processors, cause operations for identifying one or more variables as principal drivers of change for a value of interest, comprising:
obtaining a request for identifying one or more variables from a set of variables as principal drivers of change for a value of interest, wherein the request comprises (1) the set of variables, (2) a baseline dataset, and (3) an updated dataset, wherein the updated dataset exhibits a change in the value of interest as compared to the baseline dataset;
generating, using one or more machine learning models, a baseline model indicative of a relationship between the value of interest and each variable of the set of variables based on the baseline dataset and an updated model indicative of a relationship between the value of interest and each variable of the set of variables based on the updated dataset;
generating (1) a first plurality of plots, wherein each plot of the first plurality of plots illustrates the relationship between a variable of the set of variables and the value of interest in the baseline dataset, and (2) a second plurality of plots, wherein each plot of the second plurality of plots illustrates the relationship between the variable and the value of interest in the updated dataset;
determining, for each variable of the set of variables, a differential value by comparing plots corresponding to a same variable of the set of variables from the first plurality of plots and the second plurality of plots; and
identifying, from the set of variables, the one or more variables as principal drivers of change for a value of interest based on the differential value for each variable.

14. The one or more non-transitory, computer-readable media of claim 13, wherein the instructions further cause operations comprising:
obtaining a first set of segments based on partitioning, for a variable of the set of variables, a first corresponding plot of the first plurality of plots;
obtaining a second set of segments based on partitioning, for the variable of the set of variables, a second corresponding plot of the second plurality of plots;
determining a set of differential values by comparing corresponding segments of the first set of segments and the second set of segments; and
identifying one or more segments corresponding to one or more largest differential values.

15. The one or more non-transitory, computer-readable media of claim 14, wherein partitioning the first corresponding plot comprises identifying deciles based on a distribution of values of the variable on the first corresponding plot.

16. The one or more non-transitory, computer-readable media of claim 13, wherein the instructions further cause operations comprising generating a command for displaying, to a user, one or more segments and transmitting the command to a remote device.

17. The one or more non-transitory, computer-readable media of claim 13, wherein the first plurality of plots comprises partial dependence plots, wherein a first axis of each plot identifies values of a variable, and a second axis of each plot identifies the value of interest in the baseline dataset for corresponding values of the variable.

18. The one or more non-transitory, computer-readable media of claim 13, wherein the second plurality of plots comprises partial dependence plots, wherein a first axis of each plot identifies values of a variable, and a second axis of each plot identifies the value of interest in the updated dataset for corresponding values of the variable.

19. The one or more non-transitory, computer-readable media of claim 13, wherein the instructions further cause operations comprising generating a graphical representation of the differential value for each variable and generating a command for displaying, to a user, the graphical representation.

20. The one or more non-transitory, computer-readable media of claim 13, wherein the instructions further cause operations comprising:
determining a value indicative of model performance of the baseline model and/or the updated model; and
responsive to determining that the value does not exceed a minimum threshold for model performance, generating a command for prompting a user to select a new set of variables from a superset of variables.
